(19) United States
(12) Patent Application Publication
(10) Pub. No.: US 2016/0207373 A1
(43) Pub. Date: Jul. 21, 2016

(54) CLIMATE CONTROL SYSTEM WITH AN AIR GUIDING ELEMENT

(71) Applicant: MAHLE International GmbH, Stuttgart (DE)

(72) Inventors: Norman Schaake, Markgroeningen (DE); Stefan Weichenthal, Schorndorf (DE)

(73) Assignee: MAHLE International GmbH, Stuttgart (DE)

(21) Appl. No.: 14/994,204

(22) Filed: Jan. 13, 2016

(30) Foreign Application Priority Data
Jan. 21, 2015 (DE) 10 2015 200 942.4

(51) Int. Cl. B60H 1/00

(52) U.S. Cl. CPC B60H 1/00564; B60H 2001/006

(57) ABSTRACT

A climate control system with an air guiding element is provided, whereby the air guiding element is partially permeable to air.

This nonprovisional application claims priority under 35 U.S.C. §119(a) to German Patent Application No. 10 2015 200 942.4, which was filed in Germany on Jan. 21, 2015, and which is herein incorporated by reference.

### BACKGROUND OF THE INVENTION

1. Field of the Invention

The invention relates to a climate control system with an air guiding element, particularly for a motor vehicle.

2. Description of the Background Art

So-called air guiding elements within a climate control system having a housing and heat exchangers disposed therein, apart from their main function of conveying air, also have the function of mixing air to achieve a uniform temperature distribution of the flowing air. The use of air guiding elements makes possible the selective development of control curves required for the thermodynamic function of vehicle climate control systems. Such air guiding elements have become known from DE 10 2013 014 766 A1, DE 10 2006 050 181 A1, and DE 10 2010 027 272 A1.

Apart from the aspect of the thermodynamic function, however, the aspect of acoustics must also be considered in the development of climate control systems for motor vehicles to assure high passenger satisfaction. It has not been possible so far, however, to reconcile optimal thermodynamic function of the climate control system with optimal acoustic values, therefore the quietest climate control system possible, because some elements for optimizing control curves greatly worsen the acoustics of the climate control system, since their effect is based on blocking of cross sections, flow separation, and turbulence generation. The blocking elements in particular can affect the acoustics of the climate control system perhaps so greatly that they ultimately cannot be implemented in the air guiding part, because the acoustic objectives cannot be achieved. Due to their position within the housing of the climate control system in the direct air path to the air outlets, these air guiding elements have a great effect on acoustics. Such air guiding elements are therefore necessary for control curve development and the thermodynamic function of the climate control device, but are more likely to have negative effects acoustically because of the obstruction of cross sections, flow separation, and turbulence generation that they cause. For this reason, compromises were necessary so far between an optimal thermodynamic function and optimal acoustics in the development of climate control systems of motor vehicles.

### SUMMARY OF THE INVENTION

It is therefore an object of the present invention, on the one hand, is to assure a thermodynamic function, as faultless as possible, of a climate control system and, on the other, to minimize acoustic disadvantages of the climate control system.

An exemplary embodiment of the invention provides a climate control system having a housing with heat exchangers and air ducts disposed therein, whereby an air guiding element is disposed in the housing, the air guiding element being formed partially permeable to air. As a result, in the case of a thermodynamically necessary partial blocking of an air flow direction, flow through the air guiding element can be allowed to minimize increases in the flow velocity and separation phenomena and the associated acoustic disadvantages.

The basic flat structure of the air guiding element can have at least one opening or a plurality of openings. These can be introduced, for example, into an air guiding element, which is formed as a sheet metal part or as a plastic panel.

According to an embodiment of the invention, the air guiding element can have a hole pattern. The openings in the hole pattern can be formed and arranged such that the air-conducting and thermodynamic action of the air guiding element is retained at inflow velocities typical for climate control systems, but simultaneously so much air can flow through that the acoustics of the climate control device are not negatively influenced. In this regard, the air flow can be designed with only local turbulence generation and with relatively low separation phenomena.

There are advantages of over 1 dB(A) in acoustic measurements by the air guiding elements of the invention in comparison with an air-impermeable air guiding element. The air guiding elements of the invention therefore are almost at the level of measurements without any air guiding elements. Depending on the inflow velocity and the inflow direction and the associated pressure drop at the particular hole pattern, permeable air guiding elements can be designed with a nonlinear characteristic.

The shape of the holes in this case can be round and/or angular, for example, rectangular or square. The distribution of the openings can be regular, and therefore can follow a symmetric pattern. In certain applications, an irregular distribution of the openings can also be of advantage. The ratio of the web width to the opening area in the air guiding element of the invention can also be adjusted specifically.

According to an embodiment of the invention, the air guiding element has an opening ratio, which is calculated from the quotient of the sum of the surfaces of the open areas due to the openings and the total area of the air guiding part, whereby this opening ratio can be between 0.3 and 0.8. This is especially advantageous, because from the acoustic standpoint an opening ratio greater than or equal to 0.3 is recommendable in order to achieve an almost noise-neutral effect. From the thermodynamic standpoint, an opening ratio less than or equal to 0.8 is recommendable to assure the thermodynamic function.

During the development of air guiding elements, other components necessary for air conveyance within a vehicle climate control system can also be provided structurally with suitable hole patterns.

The introduction of other partially air-permeable materials at appropriate locations within the housing or an air duct of a climate control system can also be advantageous.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawing which is given by way of illustration only, and thus, is not limitive of the present invention, and wherein the sole FIGURE illustrates an example embodiment, showing a cross-sectional view of an adjustment fitting with sealing of the eccentric receiving space.

### DETAILED DESCRIPTION

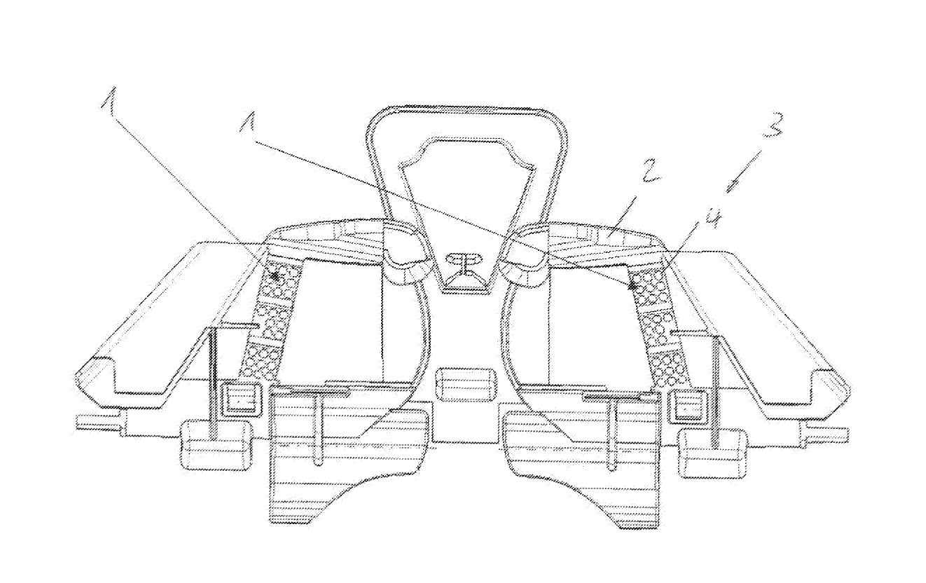

FIG. 1 shows two air guiding elements 1 of the invention, which are built or provided in a housing 2 of a climate control system 3 of a motor vehicle and are partially permeable to air. The partial permeability to air is realized by a hole pattern of openings 4, which is introduced into air guiding element 1. In this regard, air guiding element 1 can be formed as an element made of sheet metal or as a plastic panel. Openings 4 can be produced, for example, by punching out or drilling but can also be incorporated into the injection molding process, for example. The openings of the hole pattern in FIG. 1 are illustrated with having a round shape. Alternatively, openings 4 of the hole pattern can also be arranged in an angular, particularly rectangular or square arrangement. Openings 4 themselves can also be made round or angular or in some other shape.

The shape of openings 4, the hole distribution, and the ratio of the web width to hole area, therefore the opening ratio of air guiding element 1, are adjustable parameters of air guiding element 1. The opening ratio of air guiding element 1, therefore the open area created by openings 4 of air guiding element 1 divided by the total area of air guiding element 1, can be between 0 and 1. From the acoustic standpoint, an opening ratio greater than or equal to 0.3 is recommendable to achieve an almost noise-neutral effect. From the thermodynamic standpoint, an opening ratio less than or equal to 0.8 is recommendable to assure the thermodynamic function.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A climate control system comprising:
a housing with heat exchangers and air ducts optionally disposed therein; and
an air guiding element disposed in the housing, the air guiding element being formed partially permeable to air.

2. The climate control system according to claim 1, wherein the air guiding element has a basic flat structure.

3. The climate control system according to claim 1, wherein the air guiding element has at least one opening or a plurality of openings.

4. The climate control system according to claim 3, wherein the plurality of openings are arranged in a hole pattern in the air guiding element.

5. The climate control system according to claim 4, wherein the openings of the hole pattern are arranged in a round or angular or rectangular or square arrangement.

6. The climate control system according to claim 4, wherein the air guiding element has an opening ratio, which is calculated from a quotient of the sum of the surfaces of open areas due to the openings and a total area of the air guiding part, wherein the opening ratio is substantially in the range of 0.3 to 0.8.
